(19) United States
(12) Patent Application Publication
(10) Pub. No.: US 2012/0080951 A1
(43) Pub. Date: Apr. 5, 2012

(54) POWER SOURCE CIRCUIT AND POWER SOURCE MANAGEMENT METHOD THEREOF

(75) Inventors: Kuo-Sen KUNG, Hsin-Chu (TW); Chun-Hao TU, Hsin-Chu (TW); Ren-Hong JHAN, Hsin-Chu (TW); Wei-Jhih LIAN, Hsin-Chu (TW); Yu-Jung LIU, Hsin-Chu (TW); Jiun-Jye CHANG, Hsin-Chu (TW); Po-Lun CHEN, Hsin-Chu (TW)

(73) Assignee: AU OPTRONICS CORP., Hsinchu (TW)

(21) Appl. No.: 13/205,945

(22) Filed: Aug. 9, 2011

(30) Foreign Application Priority Data
Oct. 1, 2010 (TW) 099133591

(51) Int. Cl. H02J 7/34

(52) U.S. Cl. 307/48

(57) ABSTRACT

A power source circuit includes a power source detection unit, a control unit and a switch unit. The power source detection unit detects whether a plurality of power sources including a green power source is supplied to the power source circuit, and detects and outputting a power value of the green power source. In addition, the control unit is electrically coupled to the power source detection unit and a load, and the control unit further detects a power consumption value of the load, to generate a switch signal to the switch unit according to the power consumption value of the load and a result detected by the power source detection unit. Therefore, the switch unit selects the green power source and at least one of other power sources thereof to supply electric power to the load when necessary.

### TECHNICAL FIELD

The disclosure relates to a technology of power source management, and more particularly to a management method for power sources including a green power source and a commercial power source.

### RELATED ART

For various current portable electronic products, such as personal digital assistant (PDA), notebook computer, electronic dictionary, digital camera, etc., batteries are an essential element thereof. Since secondary batteries (or called “rechargeable batteries”) which may be recharged again and again are economy and fit with the environmental need, they are widely used in the portable electronic products. Furthermore, lithium batteries of the rechargeable batteries are most popular in use.

The secondary batteries must be charged by corresponding battery chargers configured for converting the commercial power source into the charging power source, and charging the secondary batteries by the charging power source. However, if users go outside and cannot obtain the charging power source, the battery chargers will not operate and the users cannot use the portable electronic products for a long time.

Therefore, the green power source which may be achieved everywhere and be regenerated, is developed as the power source charging the rechargeable batteries. For conventional technologies using the green power source to charge the rechargeable batteries, the electronic products cannot be connected to the green power source and the commercial power source simultaneously, and only select one thereof as the power source. However, the above design is not flexible. For example, when the green power source and the commercial power source are supplied to the electronic products simultaneously, the electronic products will give up the green power source and use the commercial power source to supply the electrical power thereto if the output power of the green power source is not enough. Thus, the green power source cannot be effectively used.

### SUMMARY

The present invention relates to a power source circuit, which can flexibly manage a plurality of power sources to supply electric power to a load.

The present invention relates to a power source management method, which can flexibly use a green power source to supply electric power to a load.

The present invention provides a power source circuit, which comprises a power source detection unit, a control unit and a switch unit. The power source detection unit detects whether a plurality of power sources including a green power source is supplied to the power source circuit, and detects a power value supplied by the green power source. The control unit is electrically coupled to the power source detection unit and a load, and the control unit further detects a power consumption value of the load, to generate a switch signal to the switch unit according to the power consumption value of the load and a result detected by the power source detection unit. The switch unit is electrically coupled to the control unit and the power source detection unit. Therefore, the switch unit selects the green power source and at least one of other power sources to supply electric power to the load when necessary.

In addition, the present invention also provides a power source management method. The power source management method comprises providing a green power source and detecting whether an additional power source exists; detecting a power consumption value of a load and detecting a power value of the green power source; and using the green power source and the additional power source to supply electric power to the load when the power value of the green power source is less than the power consumption value of the load and the additional power source exists.

The present invention can detect the power value of the green power source and the power consumption value of the load, and use the green power source and the additional power source together to supply the electric power to the load when the power value of the green power source is less than the power consumption value of the load. Therefore, the present invention can flexibly manage the power sources, and effectively supply the electric power to the load. In addition, the present invention also can maximize the efficiency of the green power source, and reduce the use of the non-green power source.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram of a power source circuit in accordance with an exemplary embodiment of the present invention.

FIG. 2 is a block diagram of a power source detection unit in accordance with an exemplary embodiment of the present invention.

FIG. 3 is a block diagram of a switch unit and a load in accordance with an exemplary embodiment of the present invention.

FIG. 4 is a flow chart of a power source management method in accordance with an exemplary embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

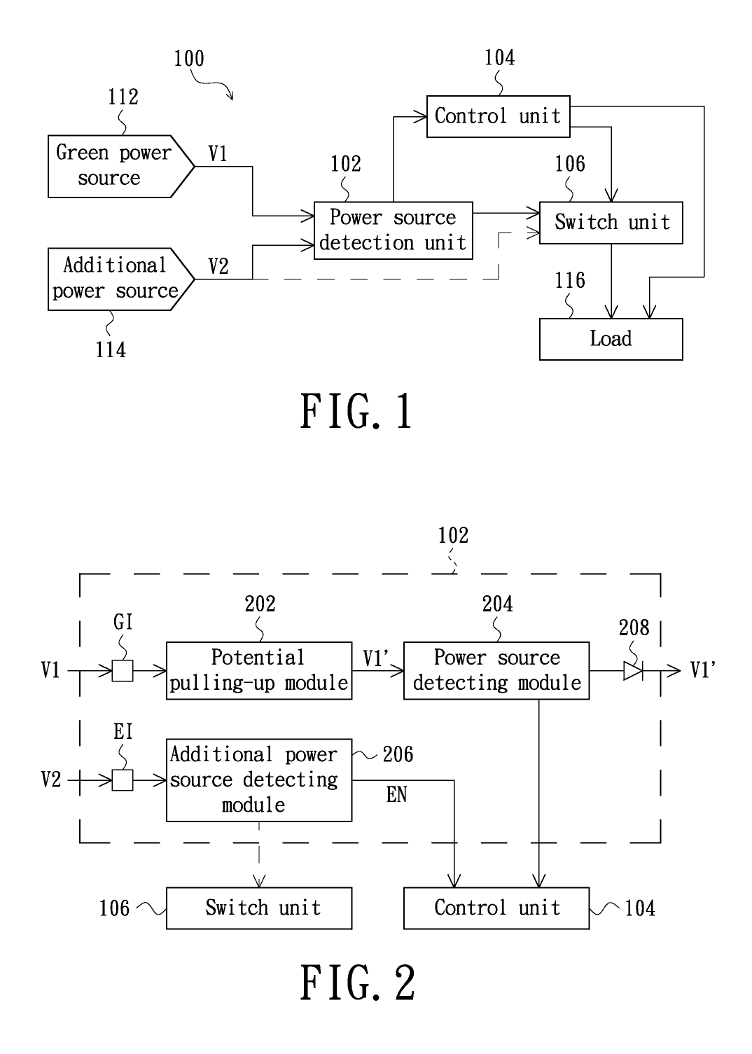

FIG. 1 is a block diagram of a power source circuit in accordance with an exemplary embodiment of the present invention. Referring to FIG. 1, the power source circuit 100 of the exemplary embodiment comprises a power source detection unit 102, a control unit 104 and a switch unit 106. In the exemplary embodiment, the power source detection unit 102 is electrically coupled to the control unit 104 and the switch unit 106, and the control unit 104 and the switch unit 106 is further electrically coupled to a load 116.

Referring to FIG. 1 again, the power source detection unit 102 is configured for detecting whether a plurality of power sources including a green power source 112 (and an additional power source) is supplied to the power source circuit 100. When the green power source 112 is supplied to the power source circuit 100, the green power source 112 may generate an output voltage V1 to the power source detection unit 102. Alternatively, the power source detection unit 102 may further be electrically coupled to a plurality of green power sources, and the green power sources may comprises a power source generated by solar energy, a power source generated by thermal energy, and a power source generated by mechanical energy. Specifically, the power source detection unit 102 may further be electrically coupled to at least one additional power source 114 except of the green power source 112, and the additional power source 114 may be a non-green power source, such as the commercial power source. In the exemplary embodiment, when the additional power source 114 is supplied to the power source circuit 100, the additional power source 114 can generate an output voltage V2 to the power source detection unit 102.

FIG. 2 is a block diagram of a power source detection unit in accordance with an exemplary embodiment of the present invention. Referring to FIG. 1 and FIG. 2, the power source detection unit 102 of the exemplary embodiment comprises a green power source receiving terminal GI, an additional power source receiving terminal EI, a potential pulling-up module 202, a power source detecting module 204 and an additional power source detecting module 206. The potential pulling-up module 202 is electrically coupled between the green power source receiving terminal GI and the power source detecting module 204. The power source detecting module 204 is further electrically coupled to the control unit 104. In addition, the addition power source detecting module 206 is electrically coupled between the additional power source receiving terminal EI and the control unit 104.

When the green power source 112 is supplied to the power source circuit 100, the output terminal of the green power source 112 is electrically coupled to the green power source receiving terminal GI. Therefore, the output voltage V1 is transmitted to the potential pulling-up module 202 through the green power source receiving terminal GI. When the potential pulling-up module 202 receives the output voltage V1, the potential of the output voltage V1 is pulled up to a predetermined output voltage V1′. Then, the predetermined output voltage V1′ is supplied to the power source detecting module 204. At this moment, the power source detecting module 204 detects the power value supplied by the green power source 112, and transmits a result thereof to the control unit 104.

Alternatively, the power source detection unit 102 further comprises a unilateral conducting element 208, such as a diode. In the exemplary embodiment, the anode of the diode 208 is electrically coupled to the power source detecting module 204, and the cathode thereof is electrically coupled to the switch unit 106. Therefore, the pulled-up output voltage V1′ is transmitted to the switch unit 106 through the diode 208, the diode 208 is assumed to be an ideal diode, and there is no potential difference between the anode and the cathode thereof herein.

On the other hand, when the additional power source 114 is supplied to the power source circuit 100, the output terminal of the additional power source 114 is electrically coupled to the additional power source receiving terminal EI. When the additional power source detecting module 206 detects the additional power source 114 is electrically coupled to the additional power source receiving terminal EI, an enable signal EN is generated to the control unit 104.

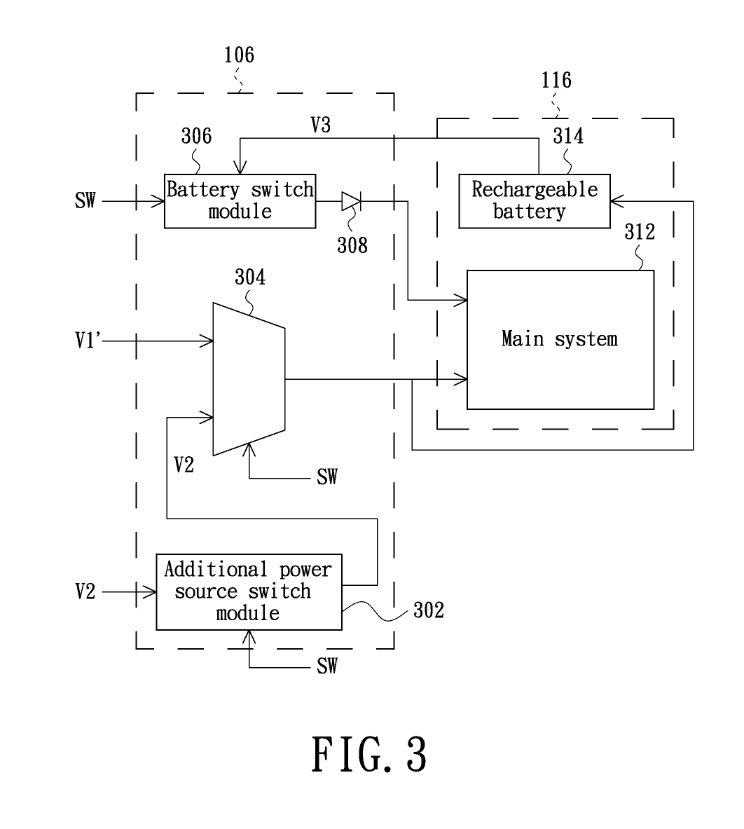

FIG. 3 is a block diagram of a switch unit and a load in accordance with an exemplary embodiment of the present invention. Referring to FIG. 1 to FIG. 3, the switch unit 106 comprises an additional power source switch module 302 and a power source management module 304. When the additional power source 114 as shown in FIG. 1 is supplied to the power source circuit 100, the electric power outputted from the additional power source 114 is transmitted to additional power source detecting module 206 through the additional power source receiving terminal EI, and is supplied to the additional power source switch module 302. Alternatively, the electric power outputted from the additional power source 114 also may be directly transmitted to the additional power source switch unit 302. In additional, the output terminal of the additional power source switch module 302 is electrically coupled to an input terminal of the power source management module 304. In the exemplary embodiment, another input terminal of the power source management module 304 is electrically coupled to the cathode of the diode 208 as shown in FIG. 2, for receiving the pulled-up output voltage V1′.

An output terminal of the power source management module 304 may be electrically coupled to the load 116. In the exemplary embodiment, the load 116 may be an electronic system, such as desktop computer, portable computer, mobile phone, personal digital assistant (PDA), pocket computer, portable video player, or digital camera, etc. In the exemplary embodiment, the load 116 comprises a main system 312 electrically coupled to the power source management module 304. Therefore, when the power source management module 304 receives the output voltages V1′ and V2, it can supply at least one of the output voltages V1′ and V2 to the main system 312, such that the load 116 can normally operate.

Alternatively, the load 116 may further comprise a rechargeable battery 314, such as lithium battery. In addition, the switch unit 106 comprises a corresponding battery switch module 306 disposed therein, which is electrically coupled to the rechargeable battery 314. Alternatively, the switch unit 106 may further comprise a unilateral conducting element 308, such as a diode. The anode of the diode 308 is electrically coupled to the power source switch module 306, and the cathode thereof is electrically coupled to the main system 312.

Referring to FIG. 1 to FIG. 3, when the load 116 operates, the control unit 104 can detect the power consumption value of the load 116 in operation. At this moment, if the green power source 112 is supplied to the power source circuit 100, the control unit 104 can compare the power consumption value of the load 116 and the power value of the output voltage V1′ detected by the power source detecting module 204, and generate a switch signal SW according to a result thereof to the additional power source switch module 302 and the power source management module 304.

When the power value of the output voltage V1′ is larger than the power consumption value of the load 116 in operation, the additional power source switch module 302 is in disable state according to the switch signal SW. At the moment, the additional power source switch module 302 does not output the electric power. In addition, the power source management module 304 can select the output voltage V1′ to supply the electric power to the load 116 in operation according to the switch signal SW.

Without the additional power source, if the rechargeable battery 314 has an enough electric power storage to supply the electric power to the main system 312 in operation, the battery switch module 306 will supply the output voltage V3 supplied by the rechargeable battery 314 to the main system 312 through the diode 308 according to the switch signal SW. On the contrary, when the control unit 104 detects the power value of the output voltage V1′ is less than the power consumption value of the load 116, and the additional power source 114 is supplied to the power source circuit 100, another switch signal SW is generated to the additional power source switch module 302 and the power source management module 304. At the moment, the additional power source switch module 302 is in enable state and transmits the output voltage V2 to the power source management module 304. In addition, the power source management module 304 supplies the output voltages V1′ and V2 to the main system 312 and/or the rechargeable battery 314 according to the switch signal SW, such that the main system 312 can normally operate or the rechargeable battery 314 may be charged. When charging the rechargeable battery 314, the battery switch module 306 is in disable state according to the switch signal SW, to stop supplying the output voltage V3 of the rechargeable battery 314 to the main system 312.

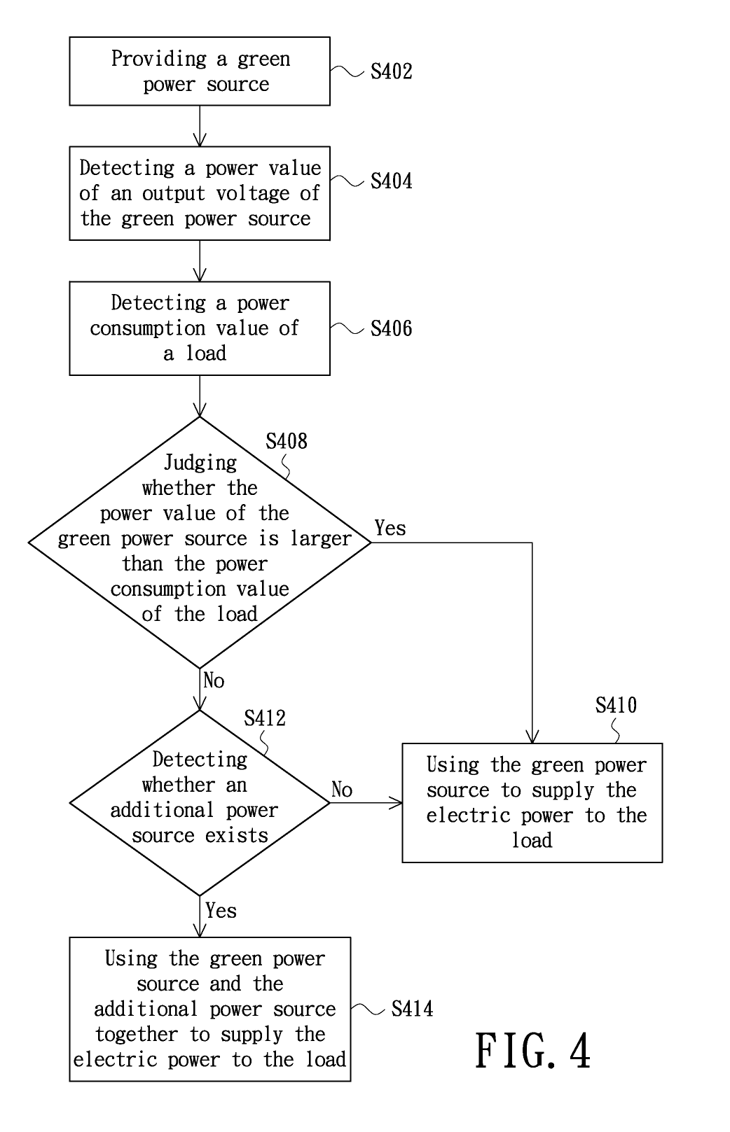

FIG. 4 is a flow chart of a power source management method in accordance with an exemplary embodiment of the present invention. Referring to FIG. 4, the power source management method of the exemplary embodiment may firstly provide a green power source as shown in step S402. Preferably, the green power source may be a power source generated by solar energy, a power source generated by thermal energy, or a power source generated by mechanical energy. Then, the power value of the output voltage of the green power source is detected as shown in step S404. In addition, the power consumption value of the load is detected as shown in step S406. Finally, it judges whether the power value of the output voltage of the green power source is larger than the power consumption value of the load as shown in step S408.

If the power value of the output voltage of the green power source is larger than the power consumption value of the load (that is yes indicated by step S408), it means the output voltage of the green power source can support the load in operation. Therefore, the output voltage of the green power source is supplied to the load as shown in step S410. On the contrary, if the power value of the output voltage of the green power source is less than the power consumption value of the load (that is no indicated by step S408), it needs performing step S412 to detect whether the additional power source exists.

If detecting the additional source exists in step S412 (that is yes indicated by step S412), the electric powers supplied by the green power source and the additional power source are supplied to the load together for supporting the load in operation. On the contrary, if detecting no additional power source (such as the commercial power source or the battery) exists in step S412 (that is yes indicated by step S412), it will return to step S410.

The following will provide two tables for describing the principle of the power source management method as shown in FIG. 4 in detail.

TABLE 1

| | | load | | | |
|---|---|---|---|---|---|
| | | battery | | | |
| | | whether additional power source exists | | | |
| | | no | | yes | |
| | | objective | | objective | |
| | | load | sequence | load | sequence |
| power | additional | X | X | battery | 2 |
| source | power | | | | |
| supplied | source | | | | |
| to load | green power | battery | 1 | battery | 1 |
| | source | | | | |
| | battery | X | X | X | X |

In Table 1, the load is just the battery. In other words, the battery needs to be charged and the main system is not open. In a first condition, that is, the additional power source does not exist and only the green power source exists to supply the electric power to the load. At the moment, the objective load is just the battery. In addition, the green power source is a sole power source, thus the sequence thereof is first.

In a second condition, the load is still the battery. The difference from the first condition is that, there are the additional power source and the green power source in the second condition. In addition, the objective load is still the battery. At the moment, the sequence of the green power source supplying the electric power to the load is still first. The difference from the first condition is that, the sequence of the additional power source supplying the electric power to the load is second. In detail, when the output voltage of the green power source is enough to charge the battery and can charge the battery for a certain period, only the green power source is used to charge the battery. However, if the green power source cannot charge the battery for the certain period, the output voltage of the additional power source is used also to charge the battery, to improve the charging efficiency thereof.

TABLE 2

| | | load | | | |
|---|---|---|---|---|---|
| | | main system and battery | | | |
| | | whether additional power source exists | | | |
| | | no | | yes | |
| | | objective | | objective | |
| | | load | sequence | load | sequence |
| power | additional | X | X | main | 2 |
| source | power | | | system | |
| supplied | source | | | and | |
| to load | | | | battery | |
| | green power | main | 1 | main | 1 |
| | source | system | | system | |
| | | | | and | |
| | | | | battery | |
| | battery | main | 2 | X | X |
| | | system | | | |

In Table 2, the load is the main system and the battery. That is, not only the battery is charged but also the main system operates. Therefore, in a third condition of no additional power source existing, the sequence of the green power source supplying the electric power to the load is first, and the sequence of the battery supplying the electric power to the load is second. In other words, when the output voltage of the green power source is enough to support the main system in operation and charge the battery, only the output voltage of the green power source is supplied to the load. However, if the output voltage of the green power source is not enough to be supplied to both of the main system and the battery simultaneously, the battery is not used as the load and is used as another power source. At the moment, the output voltages of the battery and the green power source are supplied to the main system together, such that the main system may normally operate.

In a fourth condition, the load is still the main system and the battery. The difference from the third condition is that, there is the additional power source exists. Therefore, the sequence of the green power source supplying the electric power to the load is first, and the sequence of the additional power source supplying the electric power to the load is second. The principle of work of the green power source and the additional power source is similar with that in the second condition, and is not described in detail.

In addition, if no additional power source exists and the green power source is not enough to support the load in operation, it will force the battery to supply the electric power to the load, such that the load can normally operate.

In summary, the present invention can determine whether using the green power source and the additional power source together to supply the electric power to the load, according to the relationship between the power value of the output voltage of the green power source and the power consumption value of the load. Therefore, the present invention can flexibly select the power source of the load, and the potency of the load will not be decreased because the output power of the green power source is not enough. In addition, the usage of the green power source can be enhanced in maximum, and the dependence on the non-green power source can be reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power source circuit, comprising:
a power source detection unit, detecting whether a plurality of power sources including a green power source is supplied to the power source circuit, and detecting a power value supplied by the green power source;
a control unit, electrically coupled to the power source detection unit and a load, the control unit further detecting a power consumption value of the load, and generating a switch signal according to the power consumption value of the load and a result detected by the power source detection unit; and
a switch unit, electrically coupled to the control unit and the power source detection unit, and configured for selecting the green power source and at least one of other power sources of the plurality of power sources to supply electric power to the load when the power value of the green power source is less than the power consumption value of the load.

2. The power source circuit according to claim 1, wherein the plurality of the power sources comprise an additional power source, when the control unit determines the green power source is not enough to supply an electric power needed by the load according to the power value outputted from the power source detection unit, the control unit outputs the switch signal to the switch unit such that the switch unit is controlled to use the additional power source and the green power source to supply the electric power to the load simultaneously.

3. The power source circuit according to claim 1, wherein the power source comprises a power source generated by solar energy, a power source generated by thermal energy, and a power source generated by mechanical energy.

4. The power source circuit according to claim 1, wherein the load comprises a rechargeable battery.

5. The power source circuit according to claim 1, wherein the power source detection unit comprises:
a green power source receiving terminal, receiving the power source;
an additional power source receiving terminal, receiving an additional power source;
a potential pulling-up module, electrically coupled to the green power source receiving terminal to receive the green power source and pull up the green power source to a predetermined potential;
a power source detecting module, electrically coupled to the potential pulling-up module, for detecting the power value of the pulled-up potential of the green power source and outputting the power value to the control unit; and
an additional power source detecting module, electrically coupled to the additional power source receiving terminal, for detecting whether the additional power source is supplied to the additional power source receiving terminal and outputting a result thereof to the control unit.

6. The power source circuit according to claim 5, further comprising:
a unilateral conducting element, electrically coupled between the power source detecting module and the switch unit such that the power source detecting module unilaterally supplies the electric power to the switch unit.

7. The power source circuit according to claim 1, wherein the switch unit comprises:
a battery switch module, electrically coupled to the control unit and a battery, the battery switch module being configured for determining whether the battery supplies electric power to the load according to the switch signal;
a power source management module, electrically coupled to the control unit, the power source management module being configured for determining which of the power sources supplies the electric power to the load or the battery according to the switch signal; and
an additional power source switch module, electrically coupled to the power source detection unit, the control unit and the power source management module, the additional power source switch module being controlled by the control unit to determine whether at least one of the power sources except of the green power source supplied to the power source detection unit is supplied to the power source management module.

8. The power source circuit according to claim 7, wherein the switch unit comprises a unilateral conducting element electrically coupled between the battery switch module and the load.

9. A power source management method, comprising:
providing a green power source;
detecting whether an additional power source exists;
detecting a power consumption value of a load;
detecting a power value of the green power source; and
using the green power source and the additional power source to supply electric power to the load when the power value of the green power source is less than the power consumption value of the load and the additional power source exists.

10. The power source management method according to claim 9, further comprising:
just using the green power source to supply the electric power to the load when the power value of the green power source is larger than the power consumption value of the load.

11. The power source management method according to claim 10, wherein the step of just using the green power source to supply the electric power to the load when the power value of the green power source is larger than the power consumption value of the load, comprises:
turning off an electrical route between the additional power source and the load when the additional power source exists; and
using the green power source to supply the electric power to the load.

12. The power source management method according to claim 10, further comprising:
providing a rechargeable battery as the load; and
using the green power source to charge the rechargeable battery.

13. The power source management method according to claim 12, wherein the rechargeable battery is used to supply the electric power to the load when no additional power source exists, and the green power source is not enough to supply the electric power to the load.

14. The power source management method according to claim 10, further comprising:
providing an electronic system as the load; and
using the green power source to supply the electric power to the electronic system such that the electronic system normal operates.

15. The power source management method according to claim 9, further comprising:
providing a rechargeable battery as the additional power source.

16. The power source management method according to claim 15, wherein the rechargeable battery is uses as a part of the load when the rechargeable battery is not used as one of the power sources.
